(19) United States
(12) Patent Application Publication
(10) Pub. No.: US 2012/0265492 A1
(43) Pub. Date: Oct. 18, 2012

(54) Method, Device and System for Detecting Medical Equipment

(75) Inventor: Yonghui Chen, Beijing (CN)

(73) Assignee: BEIJING AEONMED CO., LTD., Beijing (CN)

(21) Appl. No.: 13/389,764

(22) PCT Filed: Dec. 24, 2010
(86) PCT No.: PCT/CN2010/080260

§ 371 Date: Feb. 9, 2012

(30) Foreign Application Priority Data
Dec. 31, 2009 (CN) 200910244637.4

(51) Int. Cl. G06F 15/00

(52) U.S. Cl. 702/189

(57) ABSTRACT

The present invention discloses a detection method, device and system for medical equipment, wherein the method comprises that: a detection device sends operation parameters to a detected equipment; the detection device obtains detection parameters in a case that the detected equipment operates under the operation parameters; the detection device compares the detection parameters with reference data, wherein the reference data are data obtained through detecting the detected equipment by the detection device; and the detection device determines the operation state of the detected equipment according to the comparison result. By the present invention, realized is an overall, systematic automatic detection of the operation parameters output by the detected equipment.

### FIELD OF THE INVENTION

The present invention relates to the field of medical instrument, in particular to a detection method, device, and system for the medical equipment.

### BACKGROUND OF THE INVENTION

A ventilator is a commonly-used emergency and therapy device in clinical practice, which can provide breathing support for a patient and even may fully replace a human body to aerate. Since the object to which the ventilator is applied is a seriously ill patient, it is a precondition and requirement for reducing medical risk and securing medical safety to ensure the stability and reliability of the operation of the ventilator. The medical and sanitary department must detect and check the output parameters, reliability, and safety performance of the ventilator before using the ventilator.

The detection device for the ventilator has been widely used in the fields of medical engineering and medical equipment detection and measurement, such as VT-PLUS and VT-Mobile of FLUKE, QA-VTM of METRON, RF-300 of Imtmedical, and Certifier FA Plus of TSI. These detection devices use the same detection method, all of which are capable of detecting main operation parameters of the ventilator.

In a manufacturing environment of the ventilator (anesthesia machine), since the above detection device for the ventilator fails to detect automatically, a detection person needs to record detection values of the detection device of the ventilator as well as setting parameters and measurement parameters of the detected equipment and to perform simultaneously data processing and error analysis while adjusting the setting parameters of the detected ventilator (anesthesia machine) in detecting process. In this way, an overall, systematic detection of a ventilator or an anesthesia machine takes a very long time. Moreover, such a detection process sets higher requirements for technical level and post training of an operation person.

As for the problem that the detection device for the ventilator fails to detect automatically in the related technology, no effective solution has been provided at present.

### SUMMARY OF THE INVENTION

The present invention is proposed with respect to the problem that the detection device of the ventilator fails to detect automatically in the related technology. For this purpose, the main object of the present invention is to provide a detection method, device and system for a medical equipment to solve the above problem.

In order to realize the above object, a detection method for medical equipment is provided according to one aspect of the present invention.

The detection method for the medical equipment according to the present invention includes: a detection device sends operation parameters to detected equipment; the detection device obtains detection parameters in a case that the detected equipment operates under the operation parameters; the detection device compares the detection parameters with reference data, wherein the reference data are data obtained through detecting the detected equipment by the detection device; and the detection device determines the operation state of the detected equipment according to the comparison result.

The detection device determines the operation state of the detected equipment according to the comparison result.

Preferably, before the detection device sends the operation parameters to the detected equipment to make the detected equipment operate according to the operation parameters, the method also includes: the detection device generates operation parameters.

Preferably, after the detection device sends the operation parameters to the detected equipment, the method also includes that: the detected equipment receives the operation parameters and operates according to the operation parameters.

The detection device compares the detection parameters with the reference data includes that: the detection device compares the operation parameters with the reference data.

Preferably, after the detecting device determines the operation state of the detected equipment according to the comparison result, the method also includes that: the detection device stores the determination result.

Preferably, after the detection device stores the determination result, the method also includes that: the detection device generates and outputs a detection report according to the determination result.

Preferably, the detected equipment is a ventilator or an anesthesia machine; and the operation parameters can be one of or arbitrary number of time parameters, times parameters, mode parameters, and control parameters.

In order to realize the above object, a detection device of medical equipment is provided according to another aspect of the present invention.

The detection device for the medical equipment according to the present invention includes: a sending module, configured to send operation parameters to detected equipment; an obtaining module, configured to obtain detection parameters in a case that the detected equipment operates under operation parameters; a comparison module, configured to compare the detection parameters with reference data, wherein the reference data are data obtained through detecting the detected equipment by the detection device; and a determination module, configured to determine the operation state of the detected equipment according to the comparison result.

In order to realize the above object, a detection system of medical equipment is provided according to another aspect of the present invention.

The detection system of the medical equipment according to the present invention includes: a detection device, configured to send operation parameters and determining the operation state of detected equipment according to the received result of comparing the detection parameters of the detected equipment with reference data, wherein the reference data are data obtained through detecting the detected equipment by the detection device; and the detected equipment, configured to receive the operation parameters and operating under the operation parameters.

Preferably, the detecting device is also configured to generate operation parameters.

By the present invention, a detection device sends operation parameters to detected equipment; the detection device obtains detection parameters in a case that the detected equipment operates under the operation parameters; the detection device compares the detection parameters with reference data, wherein the reference data are data obtained through detecting the detected equipment by the detection device; the detection device determines the operation state of the detected equipment according to the comparison result, such that the problem that the detection device of the ventilator fails to detect automatically in the related technology is solved, and thus simplifying the detection process and operation of the ventilator and the anesthesia machine and achieving the effect of an overall, systematic automatic detection of the operation parameters output by the detected equipment.

### BRIEF DESCRIPTION OF THE DRAWINGS

The drawings herein provide a further understanding of the present invention and form a part of the present application. The illustrative embodiments and their description of the present invention are used to explain the present invention without unduly limiting the same, wherein:

FIG. 1 is a flow chart of a detection method for medical equipment according to an embodiment of the present invention;

FIG. 2 is an operation flow chart of a detection device according to an embodiment of the present invention;

FIG. 3 is a flow chart of a preferred detection system for medical equipment according to an embodiment of the present invention;

FIG. 4 is a schematic diagram of a detection system for medical equipment according to an embodiment of the present invention; and

FIG. 5 is a schematic diagram of a detection device for medical equipment according to an embodiment of the present invention.

### DETAILED DESCRIPTION OF THE PREFERRED EMBODIMENTS

What needs to be explained is that, the embodiments and the features of the embodiments in the present application can be combined with one another in the case that no conflict arises. The present invention will be described in detail in conjunction with the embodiments and with reference to the figures.

According to an embodiment of the present invention, a detection method for medical equipment is provided.

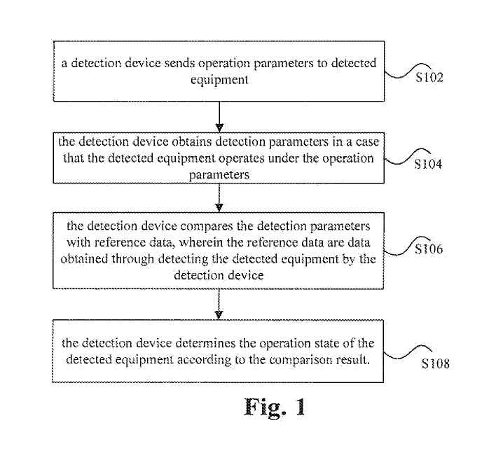

FIG. 1 is a flow chart of a detection method for medical equipment according to an embodiment of the present invention.

As shown in FIG. 1, the method includes the following Step S102 to Step S108:

Step S102, a detection device sends operation parameters to detected equipment;

Step S104, the detection device obtains detection parameters in the case that the detected equipment operates under operation parameters;

Step S106, the detection device compares the detection parameters with reference parameters, wherein the reference data are data obtained through detecting the detected equipment by the detection device; and

Step S108, the detection device determines the operation state of the detected equipment according to the comparison result.

Preferably, before the detection device sends the operation parameters to the detected equipment to make the detected equipment operate according to the operation parameters, the method also includes that: the detection device generates operation parameters.

Preferably, after the detection device sends the operation parameters to the detected equipment, the method also includes that: the detected equipment receives the operation parameters and operates according to the operation parameters.

Preferably, the detection device compares the detection parameters with the reference data, including: comparing the operation parameters with predetermined reference data.

Preferably, after the detection device compares the detection parameters with the reference data and determines the operation state of the detected equipment according to the comparison result, the method also includes: storing the determination result.

Preferably, after the detection device compares the detection parameters with the reference data and stores the determination result, the method also includes: generating and outputting a detection report according to the determination result.

Preferably, the detected equipment is a ventilator or an anesthesia machine; and the operation parameters are one of or a combination of time parameters, times parameters, mode parameters, and control parameters.

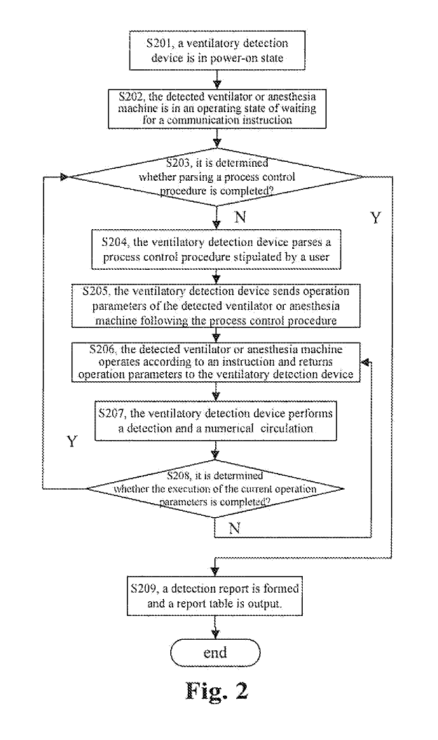

FIG. 2 is a flow chart of a preferred detection method of medical equipment according to an embodiment of the present invention.

As shown in FIG. 2, the preferred method includes the following steps:

Step S201, a ventilatory detection device is in power-on state;

Step S202, the detected ventilator or anesthesia machine is in an operating state of waiting for a communication port to receive an operation instruction;

Step S203, it is determined whether parsing a process control procedure is completed, if it is completed, Step S209 is followed, otherwise Step S204 is followed;

Step S204, the ventilatory detection device parses a process control procedure stipulated by a user;

Step S205, the ventilatory detection device sends operation parameters of the detected ventilator or anesthesia machine according to the process control procedure;

Step S206, the detected ventilator or anesthesia machine operates according to an instruction and returns operation parameters to the ventilatory detection device;

Step S207, the ventilatory detection device performs a detection and a numerical calculation;

Step S208, it is determined whether the execution of the current operation parameters is completed, if it is completed, Step S202 is followed, otherwise, Step S209 is followed; and

Step S209, a detection report is formed and a report table is output.

The implementing process of the embodiment of the present invention will be described hereinafter in detail in conjunction with examples.

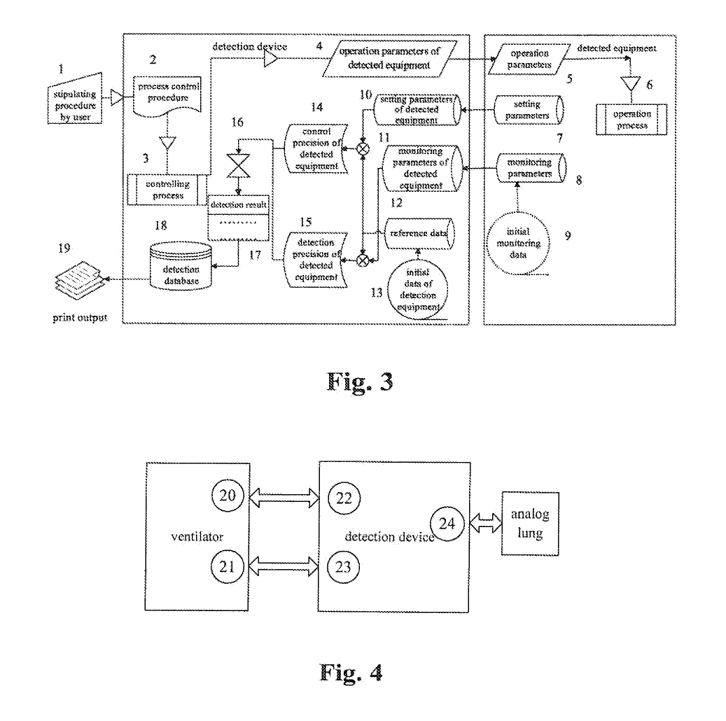

FIG. 3 is a flow chart of a preferred detection system of medical equipment according to an embodiment of the present invention; FIG. 4 is a schematic diagram of a detection system of medical equipment according to an embodiment of the present invention.

The present invention relates to the technology and device for measuring and detecting output parameters of medical equipment, in particular to how to improve operating efficiency in the case of detecting a ventilator (an anesthesia machine) during a manufacturing process and to performing an overall, systematic detection of operation parameters output by the detected equipment in the case that little labor involved. The present invention aims to raise the production efficiency of the ventilator and the anesthesia machine, to simplify the detection process and the operation of the ventilator and the anesthesia machine, to raise the automation level of the production line, and to realize the automatic detection of the ventilator and the anesthesia machine.

In the embodiment, the requirements for the ventilatory detection device include: being capable of operating according to the operation process pre-stipulated by a user; having a communication function to communicate with the detected ventilator or the anesthesia machine; being capable of detecting according to a predetermined operation process and collecting setting parameters and detection data of the detected ventilator or the anesthesia machine; and being capable of performing automatically data processing according to the predetermined operation process, displaying automatically a detection result, and outputting an operation report table.

The requirements for the detected ventilator or the anesthesia machine include: being capable of communicating with the ventilatory detection device and transferring related operation parameters; and operating according to setting parameters obtained by the communication.

The process of the automatic detection (see FIG. 2) includes that: the ventilatory detection device and the detected ventilator or anesthesia machine are in power-on state; the detected ventilator or anesthesia machine is in a state of operating according to the setting parameters obtained by communication; the ventilatory detection device parses and executes a process control procedure of a user sentence by sentence; if the parsing and executing of the process control procedure are completed, the automatic detection is ended, a detection report is made and a report table is output; the ventilatory detection device sends operation parameters to the detected ventilator or anesthesia machine according to the process control procedure; the detected ventilator or anesthesia machine operates according to the received operation parameters; the ventilatory detection device detects the operation state of the detected ventilator or anesthesia machine and receives, via communication, detection values for the operation state of the detected ventilator or anesthesia machine. On this basis, data processing and error analysis are performed, and the detection data are stored; if the execution of the current operation parameters is completed, the ventilatory detection parameters are returned to parse the next process control sentence.

As shown in FIG. 2 and FIG. 3, preferably, the specific operating process of the system is as follows:

before the operation of automatic detection, an operation person stipulates 1 a process control procedure 2 for an automatic detection; the procedure may be pre-stipulated by a technical person and used as a default process control procedure of the ventilatory detection device. After the detection begins, the ventilatory detection device parses the process control procedure 2 to form process control data 3. The ventilatory detection device sends, via communication, operation setting parameters 4 of the detected equipment to the detected ventilator or anesthesia machine according to the process control data 3. The detected equipment receives, via communication, operation setting parameters 5 of its own to form its operation process data 6. The detected equipment operates under the control of the operation process data 6 and sends via communication its operation setting parameters 7 and monitoring data 8 detected by its detection system during the operating process to the ventilatory detection device. Preferably, the detected equipment may not send the operation setting parameters 7 of its own, and the ventilatory detection device uses directly the operation setting parameters 4 previously sent to the detected equipment. The ventilatory detection device compares received setting parameters 10 and detection parameters 11 of the detected equipment with reference data 12 into which initial data 13 detected by the ventilatory detection device are converted and then computes to generate control accuracy data 14 and detection accuracy data 15 of the detected equipment, respectively. After the whole detection process of the ventilator or anesthesia machine is completed, the ventilatory detection device combines with 16 on the basis of all the previously obtained data including the control accuracy data and the detection accuracy data of the detected equipment to form the present detection result 17 and collects the present detection result 17 into a system database 18. Finally, the present detection result 17 or other detection results searched by the database 18 may be outputted 19 by printing.

During a process of the automatic detection, an airflow interface 20 of the detected equipment is connected via ventilatory pipeline with a detected equipment connection port 22 of the ventilatory detection device. A communication interface 21 of the detected equipment is connected with a communication interface 23 of the ventilatory detection device. An analog pulmonic interface 24 of the ventilatory detection device is connected with an analog lung via the ventilatory pipeline.

The above methods are merely typical embodiments of the present invention. Preferably, the corresponding processing process may be added or deleted based on the implementation of the present invention. For the person skilled in the art, the present invention may have various changes and variations. Any amendments, equivalent substitutions, improvements, etc. based on the typical embodiments of the present invention are all included in the scope of protection of the present invention.

Preferably, a method for controlling the detection process used by the detection person is to use a process control procedure and a scripting language, wherein the main elements of the process control procedure include: time quantum which are setting parameters of the ventilator or anesthesia machine such as inspiratory time, expiratory time, breath-holding time, expiratory apnea, etc.; times which is some periodic parameters controlling the automatic detection, for instance, the times for execution and the times for repetitive detection under the same operating state, and so on; breathing mode which are the operating modes of the ventilator or anesthesia machine, such as the breathing modes of VC, PC, SIMV, CPAP, PSV, etc.; control values which are setting values of the ventilator or anesthesia machine in a corresponding operating mode, such as tidal volume, inspiratory plateau pressure, auxiliary pressure, positive end-expiratory pressure, trigger sensitivity, etc.; and detecting target which are main parameters needing to be detected in different operating modes, for example, the tidal volume control and measurement accuracy of the detected equipment needs to be detected in a VC mode, while the tidal volume control and measurement accuracy do not need to be detected in a PC mode. Preferably, the process control procedure is composed of subfunctions including a number of rows of instructions and defined by a start symbol and an end symbol. These subfunctions perform one independent detection function.

Preferably, a method for synchronizing the operating states, of the detection device of the ventilator and the detected ventilator or anesthesia machine includes: synchronization of the operating states of the ventilatory detecting device and the detected ventilator or anesthesia machine is realized in a manner of serial communication (RS-232 and RS485). Synchronous communication is realized in a manner of an Ethernet network, a CAN bus, or the like according to arranging conditions of the hardware interface of the detected ventilator, wherein the synchronous communication is performed in a communication language similar to the process control procedure.

The obtaining and processing of the detection data include that: the ventilatory detection device detects the output operating state of the detected ventilator or anesthesia machine with its detecting function, and the detection result thereof is used as reference data to evaluate the operating performance including control accuracy and measurement accuracy of the detected ventilator or anesthesia machine; during a detecting process, the detected ventilator or anesthesia machine transfers setting parameters and detection parameters of the present machine in a real-time manner to the ventilatory detection device; and the ventilatory detection device realizes the computation of control error and measurement error of the detected equipment by comparing the received setting parameters and detection parameters of the detected ventilator or anesthesia machine with the reference data to realize evaluation of the function and performance of the detected equipment.

From the above description, it can be seen that in the present invention, the ventilatory detection device with a function of automatic detection is used in combination with a limited improvement of the control procedure of the ventilator or anesthesia machine to change the low-efficient operating manner in which the production detection of the ventilator or anesthesia machine is realized by performing device-by-device detection by a specific person, setting manually the detected equipment continuously, recording manually detection data, processing manually data, and filling in a report table one by one to the high-efficient operating manner in which a single person performs an automatic detection while controlling multiple equipment, which reduces significantly labor engagement and lowers the requirements for the proficiency and the professional level of the detection person. What is more important is to avoid the introduction of human error during the low-efficient detection process, such as setting error, reading error, computing error, and report table filling error of the detected equipment, and so on.

Moreover, the realization of the automatic detection of the ventilator or anesthesia machine needs the ventilator or anesthesia machine to have a function in cooperation with the automotive detection, but such a requirement brings a very small change to the ventilator or anesthesia machine, in which the detected ventilator or anesthesia machine is merely required to obtain setting parameters from a communication port rather than on a human-computer interface during the automotive detection process.

What needs to be explained is to execute the steps shown in the flow charts in a computer system such as a set of computer-executable instructions. Although the logical order is shown in the flow chart, the shown or illustrated steps can be executed in a different order therefrom in certain cases.

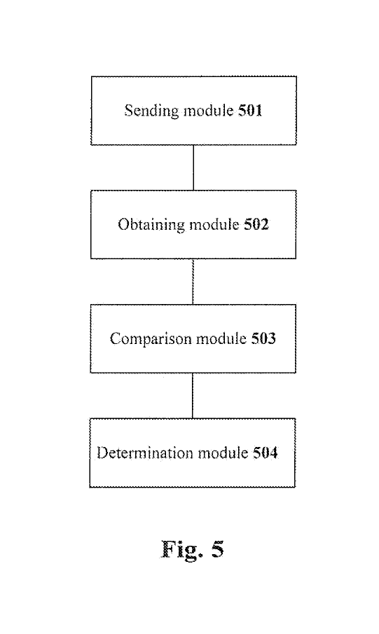

FIG. 5 is a schematic diagram of a detection device of medical equipment according to an embodiment of the present invention.

As shown in FIG. 5, the device comprises: a sending module 501, an obtaining module 502, a comparison module 503, and a determination module 504.

The sending module 501 is configured to send operation parameters to detected equipment; the obtaining module 502 is configured to obtain detection parameters in a case that the detected equipment operates under operation parameters; the comparison module 503 is configured to compare the detection parameters with reference data, wherein the reference data are data obtained through detecting the detected equipment by the detection device; and the determination module 504 is configured to determine the operation state of the detected equipment according to the comparison result.

Obviously, the person skilled in the art shall understand that the respective modules or respective steps of the present invention as mentioned above can be realized by a conventional computing apparatus, which can be integrated into a single computing apparatus or distributed over a network composed of multiple computing apparatus. Preferably, they can be realized by a program code executable by the computing apparatus, therefore, they can be stored in a storage apparatus to be executed by the computing apparatus, or they are manufactured into respective integrated circuit modules, respectively, or multiple modules or steps thereof are manufactured into a single integrated circuit module. In this way, the present invention is not limited to any specific combination of hardware and software. The descriptions above are only preferable embodiments of the present invention, which are not used to restrict the present invention. For the person skilled in the art, the present invention may have various changes and variations. Any amendments, equivalent substitutions, improvements etc. within the spirit and principle of the present invention are all included in the scope of protection of the present invention.

1. A detection method for a medical equipment, comprising:
a detection device sends operation parameters to a detected equipment;
the detection device obtains detection parameters in the case that the detected equipment operates under the operation parameters;
the detection device compares the detection parameters with reference data, wherein the reference data are data obtained through detecting the detected equipment by the detection device; and
the detection device determines the operation state of the detected equipment according to the comparison result.

2. The method according to claim 1, wherein, before the detection device sends the operation parameters to the detected equipment, the method also includes that:
the detection device generates the operation parameters.

3. The method according to claim 1, wherein, after the detection device sends the operation parameters to the detected equipment, the method also includes that: the detected equipment receives the operation parameters and operates according to the operation parameters.

4. The method according to claim 1, wherein, the detection device compares the detection parameters with the reference data, the method also includes that: the detection device compares the operation parameters with the reference data.

5. The method according to claim 1, wherein, after the detecting device determines the operation state of the detected equipment according to the comparison result, the method also includes that: the detection device stores the determination result.

6. The method according to claim 5, wherein, after the detection device stores the determination result, the method also includes that: the detection device generates a detection report and outputs the detection report according to the determination result.

7. The method according to claim 1, wherein:
the detected equipment is a ventilator or an anesthesia machine;
and the operation parameters are one of or a combination of time parameters, times parameters, mode parameters, and control parameters.

8. A detection device for a medical equipment, comprising:
a sending module, configured to send operation parameters to a detected equipment;
an obtaining module, configured to obtain detection parameters in the case that the detected equipment operates under the operation parameters;
a comparison module, configured to compare the detection parameters with reference data, wherein the reference data are data obtained through detecting the detected equipment by the detection device; and
a determination module, configured to determine the operation state of the detected equipment according to the comparison result.

9. A detection system for a medical equipment, comprising:
a detection device, sending operation parameters and determining the operation state of a detected equipment according to the received result of comparing detection parameters of the detected equipment with reference data, wherein the reference data are data obtained through detecting the detected equipment by the detection device; and
the detected equipment, receiving the operation parameters and operating under the operation parameters.

10. The system according to claim 9, wherein, the detecting device is also configured to generate the operation parameters.

11. The method according to claim 2, wherein, after the detecting device determines the Operation state of the detected equipment according to the comparison result, the method also includes that: the detection device stores the determination result.

12. The method according to claim 3, wherein, after the detecting device determines the operation state of the detected equipment according to the comparison result, the method also includes that: the detection device stores the determination result.

13. The method according to claim 4, wherein, after the detecting device determines the operation state of the detected equipment according to the comparison result, the method also includes that: the detection device stores the determination result.

14. The method according to claim 2, wherein:
the detected equipment is a ventilator or an anesthesia machine;
and the operation parameters are one of or a combination of time parameters, times parameters, mode parameters, and control parameters.

15. The method according to claim 3, wherein:
the detected equipment is a ventilator or an anesthesia machine;
and the operation parameters are one of or a combination of time parameters, times parameters, mode parameters, and control parameters.

16. The method according to claim 4, wherein:
the detected equipment is a ventilator or an anesthesia machine;
and the operation parameters are one of or a combination of time parameters, times parameters, mode parameters, and control parameters.
